(19) United States
(12) Patent Application Publication
(10) Pub. No.: US 2008/0032163 A1
(43) Pub. Date: Feb. 7, 2008

(54) Preventing corrosion during start up and shut down of a fuel cell

(76) Inventors: John D. Usborne, Vancouver (CA); Kenneth W. Kratschmar, Vancouver (CA); David A. Leboe, Vancouver (CA); Neil B. Fagan, Vancouver (CA)

Correspondence Address: TROP PRUNER & HU, PC, 1616 S. VOSS ROAD, SUITE 750, HOUSTON, TX, 77057-2631, US

(21) Appl. No.: 11/821,658

(22) Filed: Jun. 25, 2007

Related U.S. Application Data
(60) Provisional application No. 60/805,655, filed on Jun. 23, 2006.

(51) Int. Cl. H01M 8/04

(52) U.S. Cl. 429/13; 429/22; 429/23

(57) ABSTRACT

A technique includes preventing corrosion during one of start up and shut down of a fuel cell. The corrosion prevention includes controlling a load on the fuel cell during the start up/shut down to regulate a voltage of the fuel cell.

This application claims the benefit under 35 U.S.C. § 119(e) to U.S. Provisional Application Ser. No. 60/805,655, entitled, “STACK DISCHARGE PROTOCOL,” which was filed on Jun. 23, 2006, and is hereby incorporated by reference in its entirety.

### BACKGROUND

The invention generally relates to preventing corrosion during the start up and shut down of a fuel cell.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a technique includes preventing corrosion during one of start up and shut down of a fuel cell. The corrosion prevention includes controlling a load on the fuel cell during the start up/shut down to regulate a voltage of the fuel cell.

In another embodiment of the invention, a system includes a fuel cell stack, a load and a controller. The load is coupled to the fuel cell stack, and the controller controls the load during one of start up and shut down of the fuel cell stack to prevent corrosion of the fuel cell stack.

Advantages and other features of the invention will become apparent from the following drawing, description and claims.

### BRIEF DESCRIPTION OF THE DRAWING

FIGS. 1 and 5 are schematic diagrams of fuel cell-based systems according to embodiments of the invention.

FIGS. 2, 3, 4, 6 and 7 are flow diagrams depicting techniques to prevent corrosion of a fuel cell according to embodiments of the invention.

### DETAILED DESCRIPTION

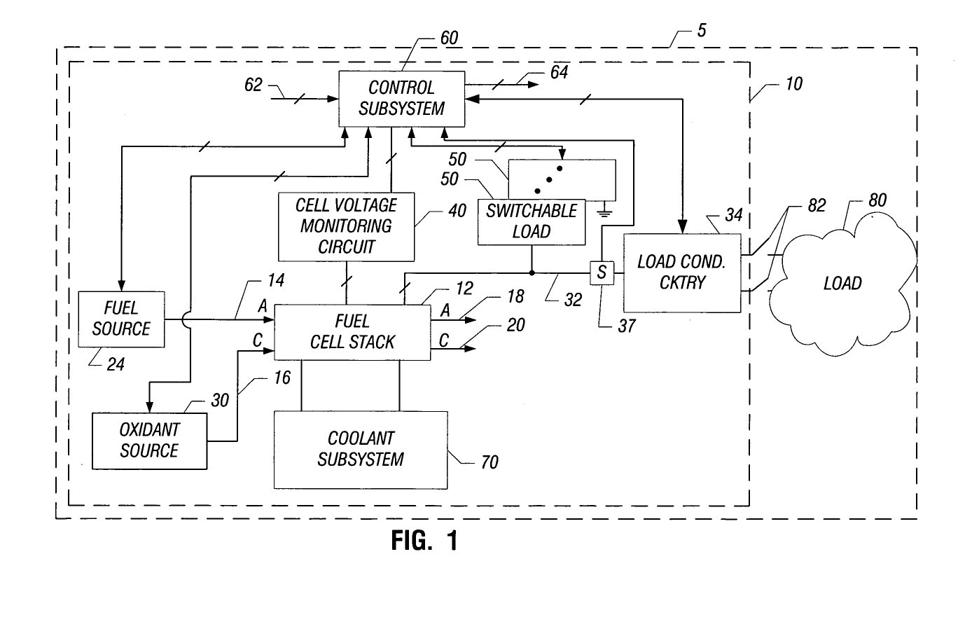

Referring to FIG. 1, an embodiment 10 of a fuel cell-based system in accordance with the invention includes a fuel cell stack 12, which generates electrical power that is consumed by an external electrical load 80. As examples, the load 80 may be an electrical load of an automobile, electrical loads of a residence, a telecommunication system, etc. In general, the fuel cell stack 12, during its normal operation, receives a fuel flow at its anode inlet 14 from a fuel source 24 (a hydrogen tank or a reformer, as examples). The incoming fuel flow is communicated through the fuel flow channels of the anode chamber of the fuel cell stack 12 to promote electrochemical reactions inside the stack 12. In some embodiments of the invention, the fuel exhaust continuously exits the anode chamber at an anode outlet 18. In other embodiments of the invention, the fuel cell stack 12 may be “dead-ended,” or “dead-headed,” which means that the anode chamber does not have a continuous anode exhaust flow, but instead, the anode chamber is intermittently purged to remove inert gases from the chamber.

The fuel cell stack 12 includes a cathode inlet 16 to receive an incoming oxidant flow from an oxidant source 30 (an air blower or compressor, as examples). The incoming oxidant flow is communicated through the oxidant flow channels of the cathode chamber of the fuel cell stack 12 to promote electrochemical reactions inside the stack 12. The oxidant flow produces a cathode exhaust at a cathode outlet 20 of the fuel cell stack 12.

It is noted that the system 10 is merely an example of one out of many possible embodiments of the invention, which are within the scope of the appended claims. As examples, depending on the particular embodiment of the invention, the anode chamber of the fuel cell stack 12 may be dead-headed (as described above); the anode 18 and/or cathode 20 outlets may be connected to a flare or oxidizer; the anode and/or cathode exhausts may be vented to ambient; etc.

In accordance with some embodiments of the invention, the fuel cell system 10 and load 80 may be portable, or mobile, and more particularly may be (as an example) part of a motor vehicle 5 (a car, truck, airplane, etc.). Thus, the fuel cell system 10 may serve as at least part of the power plant (represented by the load 80) of the vehicle. In other embodiments of the invention, the fuel cell system 10 and load 80 may be part of a stationary system. For example, the system 10 may supply all or part of the power needs of a house, electrical substation, backup power system, etc. Additionally, the system 10 may supply thermal energy to a thermal energy consuming load (water heater, water tank, heat exchanger, etc.), and thus, electrical as well as thermal loads are envisioned. Therefore, many different applications of the system and loads that consume energy from the system are contemplated and are within the scope of the appended claims.

In accordance with some embodiments of the invention, the electrical power that is produced by the fuel cell stack 12 is conditioned into the appropriate form (i.e., the appropriate AC or DC level, depending on the load 80) by load conditioning circuitry 34. The load conditioning circuitry 34 may include, as examples, one or more DC-to-DC regulators, inverters, etc., for purposes of transforming the DC stack level voltage into the appropriate AC or DC level for the load 80.

The system 10 includes a control subsystem 60, which includes various input 62 and output 64 lines for purposes of sensing conditions in the system 10 and controlling the various motors, valves, circuits, etc., of the system 10. As specifically depicted in FIG. 1, the control subsystem 60 may be electrically coupled to the fuel source 24 and to the oxidant source 30 for purposes of controlling various valves, motors, etc. of the sources 24 and 30 to regulate the start up and shut down of the fuel cell stack 12. The control subsystem 60 may also be electrically coupled to a cell voltage monitoring circuit 40, which, depending on the particular embodiment of the invention, monitors one or more cell voltages of the fuel cell stack 12 and provides indications of the measured voltages to the subsystem 60.

As a more specific example, in accordance with some embodiments of the invention, the cell voltage monitoring circuit 40 may monitor selected control cells of the fuel cell stack 12 for purposes of determining a minimum cell voltage and a maximum cell voltage of the stack 12. In other embodiments of the invention, the cell voltage monitoring circuit 40 may monitor all of the cells of the fuel cell stack 12 for purposes of determining the maximum and minimum cell voltages. The cell voltage monitoring circuit 40 may also communicate indications of the voltages of a selected group or, alternatively, the voltages of all the fuel cells to the control subsystem 60. As a specific example, the cell voltage monitoring circuit 40 may be similar in design to the cell voltage monitoring circuit that is described in U.S. Pat. No. 6,140,820, entitled “Measuring Cell Voltages Of A Fuel Cell Stack,” which granted on Aug. 31, 2000. However, the cell voltage monitoring circuit 40 may have other designs, in accordance with other embodiments of the invention. It is noted that the system 10 may not include the cell voltage monitoring circuit 40 in other embodiments of the invention, as further described below.

The control subsystem 60 may disconnect the external load 80 from the system 10 during the start up and shut down of the fuel cell stack 12. In this regard, the control subsystem 60 may open one or more switches 82, which couple the load conditioning circuitry 34 to the terminals of the load 80, for example.

It has been discovered that, if a sufficient load does not exist on the fuel cell stack 12 during its start up and shut down, the cell voltages of the fuel cell stack 12 may approach open cell voltages, which cause corrosion of the fuel cell stack 12. Therefore, in accordance with embodiments of the invention described herein, the system 10 includes switchable loads 50, which the control subsystem 60 selectively connects to the fuel cell stack 12 during the start up and shut down of the stack 12 for purposes of regulating the fuel cell voltages to prevent corrosion. It is noted that the switchable loads 50 illustrate the general concept of controlling the load on the fuel cell stack 12 for purposes of corrosion prevention. The loads 50 may be individual loads that are selectively connected to the terminals of the fuel cell stack 12 in accordance with some embodiments of the invention. However, in accordance with other embodiments of the invention, a single analog controlled load may be connected to the fuel cell stack 12 such that the control subsystem 60 controls the impedance of the analog controlled load to prevent corrosion. Other embodiments are contemplated and are within the scope of the invention.

In some embodiments of the invention, the control subsystem 60 monitors (via communications with the cell voltage monitoring circuit 40) the cell voltages of the fuel cell stack 12 during the start up and shut down of the stack 12 for purposes of regulating the cell voltages so that the voltages are always between a minimum cell voltage threshold (for purposes of maintaining healthy operation of the cells) and an upper cell voltage threshold, which defines a voltage at which corrosion is likely to occur.

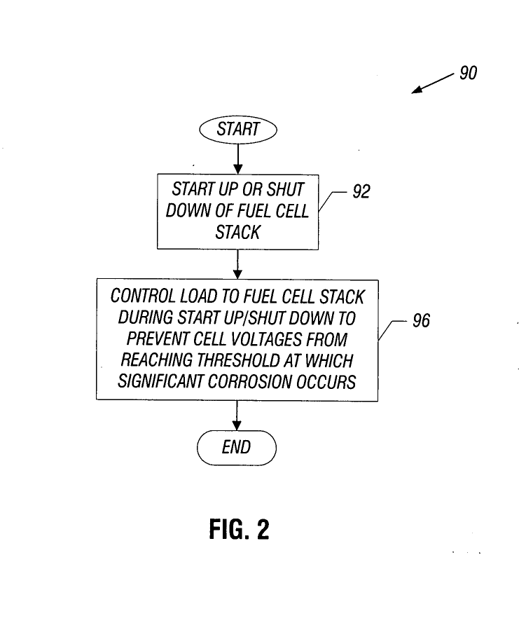

Referring to FIG. 2 in conjunction with FIG. 1, thus, in accordance with some embodiments of the invention, the system 10 may perform a technique 90 in connection with the start up and/or shut down of the fuel cell stack 12, pursuant to block 92. During the start up/shut down, the system 10 controls (block 96) the load on the fuel cell stack 12 to prevent the cell voltages of the stack 12 from reaching or exceeding a threshold voltage, which defines the voltage at which significant corrosion may occur.

Referring to FIG. 1, among its other features, the system 10 may include a coolant subsystem 70, which circulates a coolant through the fuel cell stack 12 for purposes of regulating the stack's temperature. Additionally, the system 10 may include various sensors for purposes of sensing electrical parameters associated with the fuel cell stack 12, the load conditioning circuitry 34 and the load 80. As a more specific example, in accordance with some embodiments of the invention, the system 10 includes a current sensor 37 that is electrically coupled to the stack terminals for purposes of sensing a stack current. The control subsystem 60 may monitor the stack current for purposes of determining whether the fuel cell stack 12 has transitioned from the start up state to a normal state of operation and likewise for determining whether the fuel cell stack 12 has transitioned from the normal mode of operation to being shut down.

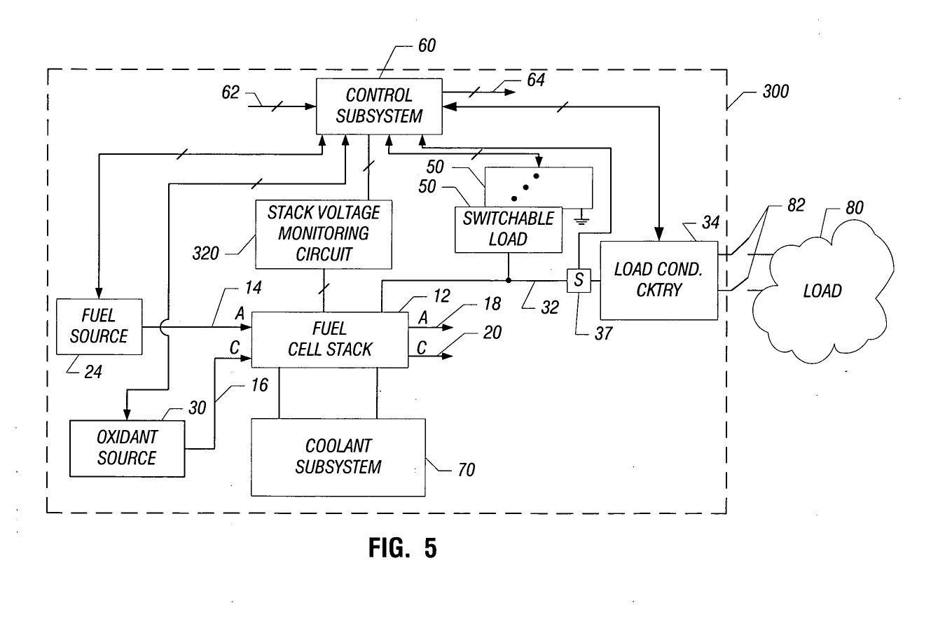

Alternatively, in accordance with other embodiments of the invention, the control subsystem 60 may use the stack voltage (i.e., the voltage across the terminals of the fuel cell stack), instead of the stack current, to determine whether the fuel cell stack has transitioned from the start up state to a normal state of operation. For these embodiments of the invention, the system 10 includes a stack voltage monitoring circuit 310 that is discussed below in connection with FIG. 5. Furthermore, in these embodiments of the invention, the control subsystem 60 may also use the stack voltage and the monitored anode pressure (obtained, for example, via a pressure sensor that is not depicted in FIG. 1) to determine whether the fuel cell stack 12 has transitioned from the normal mode of operation to being shut down. Thus, many variations are contemplated and are within the scope of the appended claims.

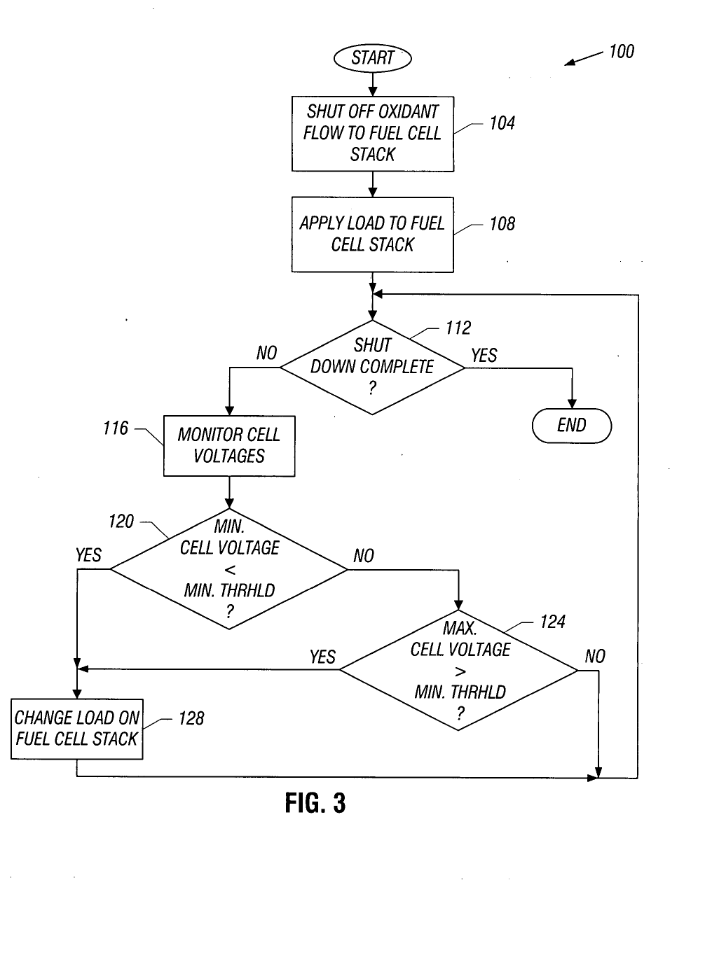

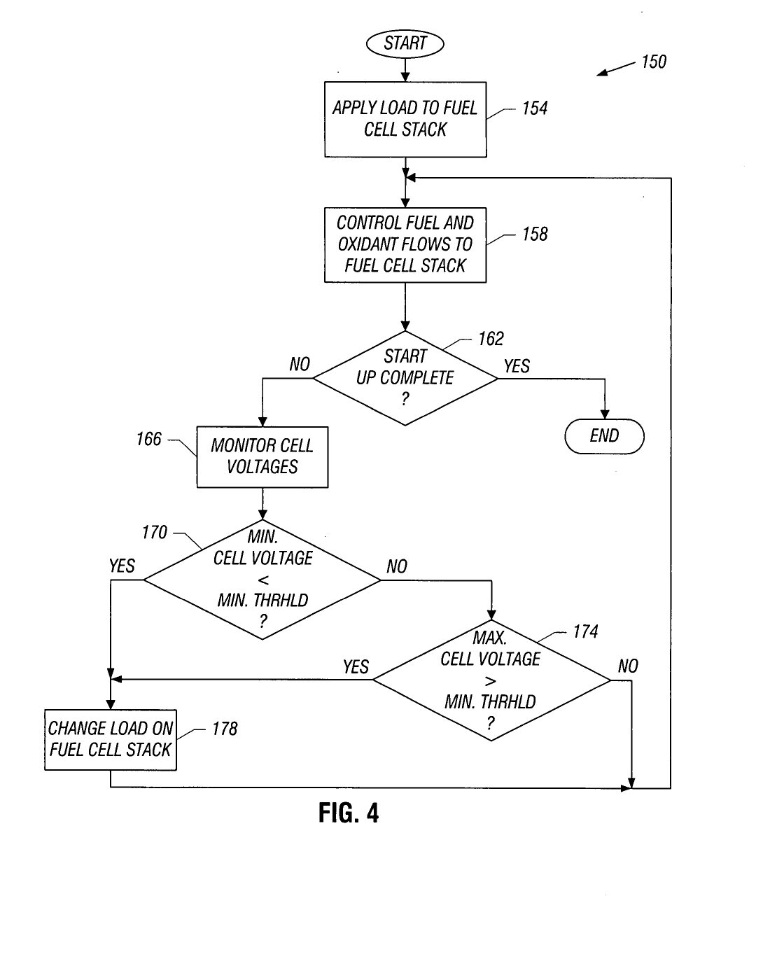

The control subsystem 60 may include, as examples, one or more microprocessors and/or microcontrollers, depending on the particular embodiment of the invention. Additionally, the controller subsystem 60 may include multiple controllers, which control the actions that are described herein. In some embodiments of the invention, the control subsystem 60 may, in general, include a processor (one or more microprocessors and/or microcontrollers, for example) that executes instructions that are stored in a memory of the control subsystem 60 for purposes of performing the technique 90 (FIG. 2) as well as other techniques (such as techniques 100 (FIG. 3) and 150 (FIG. 4) that are disclosed herein.

Referring to FIG. 3, in accordance with some embodiments of the invention, the system 10 may perform a technique 100 for purposes of shutting down the fuel cell stack 12. Pursuant to the technique 100, the system 10 shuts off (block 104) the oxidant flow to the fuel cell stack 12 and applies (block 108) a load to the fuel cell stack. It is noted that this load is controlled for purposes of regulating the cell voltages during the shut down.

More specifically, pursuant to the technique, the system 10 determines (diamond 112) whether the shut down is complete. This determination may be made, for example, by monitoring the stack current (via the sensor 37, for example). Alternatively, as set forth above, the system 10 determines whether the shut down is complete by monitoring the stack voltage and the anode pressure.

If the shut down is complete, the system 10 monitors (block 116) the cell voltages for such purposes as determining the minimum and maximum cell voltage. If the system 10 determines (diamond 120) that the minimum cell voltage is less than a minimum cell voltage threshold, then the system 10 changes (block 128) the load on the fuel cell stack 12 to increase the stack's minimum cell voltage. If the system 10 determines that the minimum cell voltage is greater than the minimum cell voltage threshold, but however, determines that the maximum cell voltage is greater than the maximum cell voltage threshold (consistent with being a voltage that might cause significant corrosion), then the system 10 also changes (block 128) the load on the fuel cell stack 12 to reduce the stack's maximum cell voltage. The above-described control continues until a determination is made pursuant to diamond 112 that the shut down is complete.

For purposes of starting up the fuel cell system, the system 10 may perform a technique 150 that is depicted in FIG. 4 in accordance with some embodiments of the invention. In the technique 150, the system 10 applies a load to the fuel cell stack, pursuant to block 154. The oxidant and fuel flows to the fuel cell stack 12 are controlled 158 for purposes of starting up the stack. For example, in accordance with some embodiments of the invention, the system 10 may first furnish a fuel flow to the fuel cell stack for purposes of charging the anode chamber (i.e., for embodiments of the invention in which the anode chamber is dead-headed) while shutting off or maintaining a small oxidant flow to the fuel cell stack.

If the system 10 determines (diamond 162) that the start up is complete, and thus, the system 10 is operating in its normal mode of operation, then the technique 150 is terminated. For example, in accordance with some embodiments of the invention, the system 10 may determine that the fuel cell stack 12 is in its normal mode of operation by monitoring the stack current. Alternatively, as set forth above, the system 10 determines whether the fuel cell stack 12 is in its normal mode of operation by monitoring the stack voltage.

If the start up is not yet complete, the system 10 monitors (block 166) the cell voltages to determine at least a minimum cell voltage and a maximum cell voltage. If the minimum cell voltage is less than the minimum cell voltage threshold (diamond 170) or the maximum cell voltage is greater than the maximum cell voltage threshold (diamond 174), the system 10 changes (block 178) the load on the fuel cell stack 12 to increase or decrease the cell voltages to regulate the cell voltages in the desired range; and control returns to block 158.

Other embodiments are contemplated and are within the scope of the appended claims. For example, FIG. 5 depicts an exemplary fuel cell system 300 in accordance with other embodiments of the invention. The system 300 has the same general design as the system 10 (see FIG. 1), with like reference numerals being used to denote similar components. However, unlike the system 10, the system 300 replaces the cell voltage monitoring circuit 40 (see FIG. 1) with a stack voltage monitoring circuit 320. In accordance with some embodiments of the invention, the stack voltage monitoring circuit 320 may be an analog circuit, such as a differential amplifier in conjunction with an analog-to-digital converter (as a non-limiting example).

Therefore, in accordance with other embodiments of the invention, the system 300 may monitor the stack voltage during the start up and shut down of the fuel cell stack 12 for purposes of preventing corrosion. More specifically, the control subsystem 60 may be in communication with the stack voltage monitoring circuit 320 for purposes of continually monitoring the stack voltage. In accordance with some embodiments of the invention, from the stack voltage, the control subsystem 60 determines an average cell voltage and controls the load on the fuel cell stack 12 during its start up and shut down based on the average cell voltage for purposes of preventing corrosion.

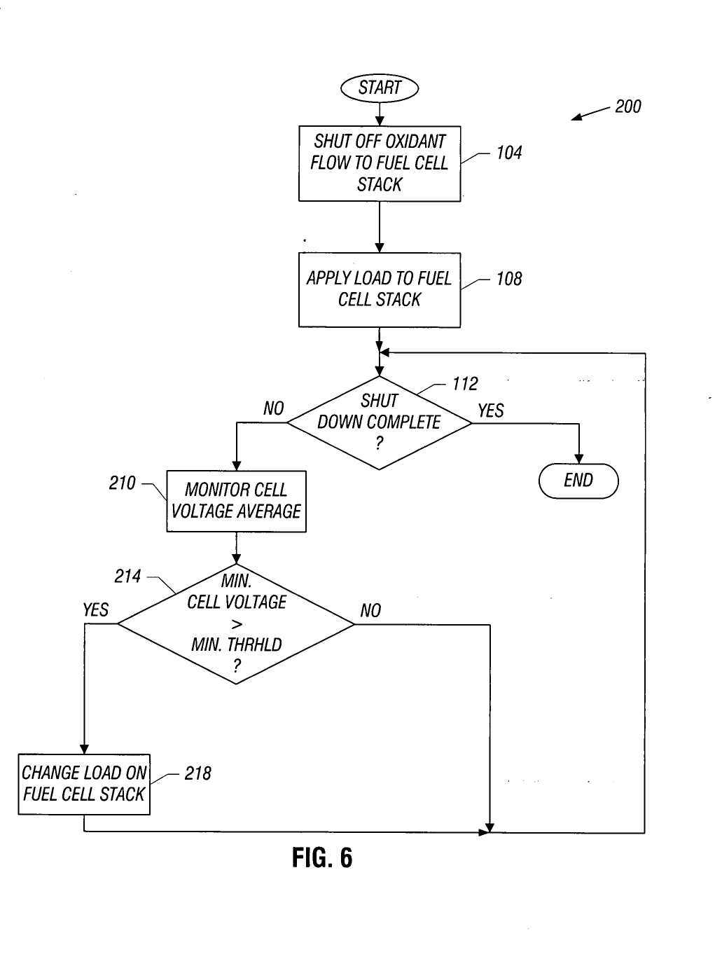

As a more specific example, the system 300 may perform a technique 200 that is disclosed in FIG. 6 during the shut down of the fuel cell stack 12. Referring to FIG. 6 in conjunction with FIG. 5, pursuant to the technique 200, the system 300 shuts off (block 104) the oxidant flow to the fuel cell stack 12 and applies a load to the stack 12, pursuant to block 108. If the system 300 determines (diamond 112) that the shut down is not complete, then the system 300 uses a monitored cell voltage average (block 210) for purposes of preventing corrosion. More specifically, the system 300 determines (diamond 214) whether the average cell voltage is greater than a predetermined maximum threshold. If not, then control returns to diamond 112. However, if the average cell voltage has exceeded the threshold, then the system 300 changes (block 218) the load on the fuel cell stack 12 for purposes of lowering the stack's average cell voltage.

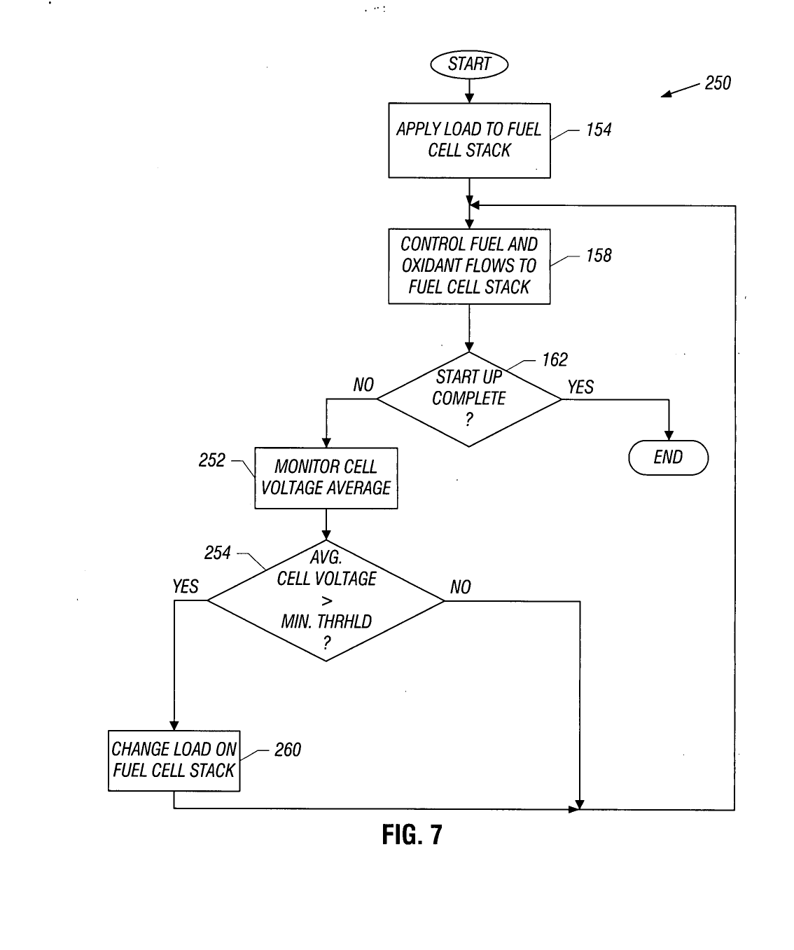

FIG. 7 depicts a technique 250, which many generally be used to prevent corrosion during the start up of the fuel cell stack 12 using a monitored cell voltage average. More specifically, referring to FIG. 7 in conjunction with FIG. 5, the system 300 applies (block 154) a load to the fuel cell stack 12 and controls (block 158) the fuel and oxidant flows to the fuel cell stack during the stack's start up. The system 300 monitors whether the start up is complete, pursuant to diamond 162. If not, then the system 300 monitors the cell voltage average, pursuant to block 252. If the system 300 determines (diamond 254) that the average cell voltage is greater than a predetermined maximum threshold, then the system 300 changes (block 260) the load on the fuel cell stack 12 for purposes of lowering the stack's voltage to prevent corrosion.

Other embodiments of the fuel cell system and corrosion prevention techniques are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
preventing corrosion during one of start up and shut down of a fuel cell, the preventing comprising controlling a load on the fuel cell during said one of start up and shut down to regulate a voltage of the fuel cell.

2. The method of claim 1, wherein the act of controlling the load comprises:
controlling the load to regulate the voltage in a range between an upper voltage threshold above which significant corrosion occurs and a lower voltage threshold associated with a minimum cell voltage.

3. The method of claim 1, wherein act of preventing comprises preventing the corrosion during the start up of the fuel cell, the method further comprising:
charging an anode of the fuel cell during the start up.

4. The method of claim 3, further comprising:
ceasing to control the load to prevent corrosion in response to determining the fuel cell has reached a non-start-up state.

5. The method of claim 4, wherein the act of determining comprises monitoring a voltage or a current of the fuel cell.

6. The method of claim 1, wherein act of preventing comprises preventing the corrosion during the shut down of the fuel cell, the method further comprising:
shutting off an oxidant flow to the fuel cell during the shut down.

7. The method of claim 6, further comprising:
ceasing to control the load to prevent corrosion in response to determining the fuel cell has shut down.

8. The method of claim 7, wherein the act of determining comprises monitoring at least one of a current and a voltage of the fuel cell.

9. A system comprising:
a fuel cell stack;
a load coupled to the fuel cell stack; and
a controller to control the load during one of start up and shut down of the fuel cell stack to prevent corrosion of the fuel cell stack.

10. The system of claim 9, wherein the controller regulates cell voltages of the fuel cell stack to prevent corrosion during said one of start up and shut down.

11. The system of claim 9, further comprising:
a voltage monitoring circuit coupled to the fuel cell stack to provide indications of at least a minimum cell voltage of the fuel cell stack and a maximum cell voltage of the fuel cell stack,
wherein the controller controls the load based on the minimum cell voltage and the maximum cell voltage during said one of start up and shut down.

12. The system of claim 11, wherein the controller is adapted to control the load to maintain the maximum cell voltage below an upper voltage threshold above which significant corrosion occurs and maintain the minimum cell voltage above a lower voltage threshold.

13. The system of claim 9, further comprising:
a fuel source adapted to charge an anode of the fuel cell stack during the start up.

14. The system of claim 9, wherein the controller is adapted to monitor a terminal voltage of the fuel cell stack and control corrosion in response to the monitored voltage.

15. The system of claim 14, wherein the controller determines an average cell voltage from the terminal voltage and controls corrosion in response thereto.

16. The system of claim 9, wherein the controller is adapted to cease controlling the load during start up to prevent corrosion in response to determining the fuel cell stack has reached a non-start-up state.

17. The system of claim 16, further comprising:
a voltage sensor to sense a voltage of the fuel cell stack,
wherein the controller is adapted to monitoring a voltage of the fuel cell and base the determination whether the fuel cell stack has reached the non start up state based at least in part of the voltage.

18. The system of claim 9, further comprising:
an oxidant source to supply an oxidant flow to the fuel cell stack,
wherein the controller is adapted to shut off the oxidant flow during the shut down of the fuel cell stack.

19. The system of claim 9, wherein the controller is adapted to cease controlling the load during the shut down of the fuel cell stack to prevent corrosion in response to determining the fuel cell stack has shut down.

20. The system of claim 19, further comprising:
a voltage sensor to sense a voltage of the fuel cell stack,
wherein the controller is adapted to monitoring a voltage of the fuel cell and base the determination whether the fuel cell stack has reached the non start up state based at least in part of the voltage

21. The system of claim 9, further comprising:
a motor vehicle,
wherein the fuel cell stack, load and controller are part of the vehicle.
